(19) United States
(12) Patent Application Publication
(10) Pub. No.: US 2012/0207451 A1
(43) Pub. Date: Aug. 16, 2012

(54) IMAGE REPRODUCTION APPARATUS FOR REPRODUCING MULTIPLE IMAGE FILES

(75) Inventors: Masahiro JUEN, Yokahama City (JP); Osamu IKEDA, Yokahama City (JP)

(73) Assignee: NIKON CORPORATION, Tokyo (JP)

(21) Appl. No.: 13/441,495

(22) Filed: Apr. 6, 2012

Related U.S. Application Data
(63) Continuation of application No. 11/602,980, filed on Nov. 22, 2006, now abandoned.
Application No. 11/602,980 is a continuation of application No. 10/102,881, filed on Mar. 22, 2002, now abandoned.
Application No. 10/102,881 is a continuation of application No. 08/934,052, filed on Sep. 19, 1997, now abandoned.
(60) Provisional application No. 60/031,871, filed on Nov. 27, 1996.

(30) Foreign Application Priority Data
Sep. 20, 1996 (JP) 8-250016

(51) Int. Cl. G11B 27/031; H04N 5/93

(52) U.S. Cl. 386/278; 386/E05.028

(57) ABSTRACT

An image reproduction device reproduces image files, which may include sound information, for example, from recording media. The image reproduction device can reproduce a group of image files following various types of editing formats within the scope of the recording capacity limited by the recording media. The recording media is capable of recording multiple image files and scenario files recorded in a predefined format, which is either the reproduction order or the reproduction style of the image files. A scenario discrimination mechanism takes the scenario files from the recording media and discriminates either the reproduction order or the reproduction style based on the file formats. A reproduction mechanism reproduces the image files read in from the recording media according to either the reproduction order or the reproduction style discriminated by the scenario discrimination mechanism.

This is a Continuation of U.S. patent application Ser. No. 11/602,980 filed Nov. 22, 2006, which is a Continuation of U.S. patent application Ser. No. 10/102,881 filed Mar. 22, 2002 (now abandoned), which in turn is a Continuation of U.S. patent application Ser. No. 08/934,052 filed Sep. 19, 1997 (now abandoned), which claims the benefit of U.S. Provisional Application No. 60/031,871 filed Nov. 27, 1996. The disclosures of these applications are incorporated herein by reference in their entireties.

The disclosure of the following priority application is herein incorporated by reference: Japanese Patent Application No. 8-250016 filed Sep. 20, 1996.

### BACKGROUND

The present invention relates to an image reproduction device that reproduces image files, which may include sound information, from recording media. The invention particularly relates to an image reproduction device that can freely reproduce multiple image files.

Recently, due to developments in digital image processing using computers, image reproduction devices have been realized that display moving images on a monitor by reproducing image files on recording media. In such image reproduction devices, individual image files are reproduced by manual selection from multiple image files.

Also, conventionally, through the use of image editing software on computers, it is possible to reproduce new image files by linking multiple image files. By performing such editing operations, it is possible, for example, to create a single video production by afterwards appropriately linking the image files reproduced one scene at a time during imaging. However, with such image editing software, there is a problem that the required file capacity of the newly created files is large after editing is finished. That is, in cases of showing one cut multiple times, the file capacity just for the number of showings becomes redundantly large.

In the present state of image compression technology, it is possible to compress the redundancy between frames. However, it is difficult to detect and compress the redundancy associated with multiple showings mentioned above, which by far exceeds the redundancy between frames.

Also, when applying various methods of image editing to a group of image files, there is the problem that image files are newly created for each round of editing. Thus, the necessary file capacity is excessive and very wasteful.

### SUMMARY

Thus, in order to solve the problems mentioned above and other problems associated with image reproduction, an object of this invention is to provide an image reproduction device capable of freely reproducing a group of image files while effectively using the recording capacity of the recording media.

Another object of the invention is to provide an image reproduction device capable of easily creating scenario files.

A further object of the invention is to provide an image reproduction device having a high reusability of scenario files.

An additional object of the invention is to provide an image reproduction device capable of creating image files in more advanced reproduction styles.

Another object of the invention is to provide an image reproduction device capable of reproducing image files without interference even when there are contradictions in the contents of the scenario files.

These and other objects are achieved by this invention, which relates to an image reproduction device comprising recording media that are capable of recording multiple image files and scenario files recorded in a predefined file format designating either the reproduction order or the reproduction style of the image files. A scenario discrimination mechanism takes the scenario files from the recording media and discriminates either the reproduction order or the reproduction style based on the file format. A reproduction mechanism reproduces the image file taken from the recording media according to either the reproduction order or the reproduction style as discriminated by the scenario discrimination mechanism.

The reproduction style is represented by at least one of any of the following: the reproduction speed of the image files, the reproduction iteration count of the image files, the reproduction range of the image files, special effects applied to the reproduction of the image files, and sound reproduction style attributed to the image files.

Identifying data pointing to other scenario files is recorded in the scenario files as data constituting the reproduction order. The scenario discrimination mechanism follows the corresponding scenario files in stages based on the identifying data recorded in the scenario files and discriminates the reproduction order of the image files.

The invention further comprises a manual reproduction mechanism that reproduces the image information recorded on the recording media according to external reproduction operations. A first scenario creation mechanism automatically records (as a scenario file) either the reproduction order or the reproduction style from the manual reproduction mechanism.

An editing input mechanism receives editing operations for the multiple image files. A second scenario creation device records (as a scenario file) either the reproduction order or the reproduction style based on editing operations input via the editing input mechanism.

The invention also includes a correction mechanism that detects contradictions when following the instructions from the scenario files and when reproducing the multiple image files. The contradictions are corrected according to either a predefined priority order or external corrective instructions.

With the image reproduction device of this invention, the scenario discrimination mechanism reads out a scenario file from the recording media. A predefined format, which is either the reproduction order or the reproduction style of the image files, has been recorded in the scenario file on the recording media. The scenario discrimination mechanism discriminates either the reproduction order or the reproduction style based on the format of this file. The reproduction mechanism then reproduces the image files from the recording media according to either the reproduction order or the reproduction style discriminated by the scenario discrimination mechanism.

In this manner, on the recording media stores both a group of image files (the substance of the image to be reproduced) and the scenario file or files. Because the scenario file(s) should record to the least extent only the data related to either the reproduction order or the reproduction style, the memory capacity of the recording media is used efficiently and without waste.

With this image reproduction device, the reproduction speed of the image files, the reproduction iteration count of the image files, the reproduction range of the image files, the special effects applied to reproduction of the image files, and the sound reproduction style attributed to the image files each may be recorded as the reproduction style. The scenario discrimination mechanism discriminates the reproduction order of the image files by following the scenario files in stages. Because it is possible in this manner to recreate a complex reproduction order by following multiple scenario files in stages, the file structures are simplified.

Also, because already edited scenario files can be easily incorporated into other scenario files, it is possible to increase the reusability of the scenario files themselves. The scenario files can be automatically created by manually recording reproduction operations. Because these scenario files can be executed from the second time on, it is not necessary to repeat again by hand the complicated reproduction operations. The scenario files can also be created based on editing operations. Contradictions of scenario files can be corrected according to either a predefined priority order or external corrective instructions.

Other objects, advantages and salient features of the invention will become apparent from the following detailed description, which taken in conjunction with the annexed drawings discloses preferred embodiments of the invention.

### BRIEF DESCRIPTION OF THE DRAWINGS

Referring now to the drawings that form a part of this original disclosure:

FIG. 1 is a high level block diagram corresponding to the operation of the basic features of the invention;

FIG. 2 is a high level block diagram corresponding to the operation of the invention showing additional features of the preferred embodiment;

FIG. 3 is a high level block diagram corresponding to the operation of the invention showing additional features of the preferred embodiment;

FIG. 4 is a high level block diagram corresponding to the operation of the invention showing additional features of the preferred embodiment;

FIG. 5 is a schematic block diagram of the preferred embodiment;

FIG. 6 is a perspective drawing explaining the external appearance of the present preferred embodiment;

FIG. 7 is a state transition diagram explaining the operations of the present preferred embodiment;

FIG. 8 is a flow chart explaining the operations of the present preferred embodiment in edit screen B;

FIG. 9 is a flow chart explaining the operations of the present preferred embodiment in edit screen C;

FIG. 10 is a flow chart explaining the operations of the present preferred embodiment in edit screen D;

FIG. 11 is a flow chart explaining the operations of the present preferred embodiment in edit screen E;

FIG. 12 is a flow chart explaining the operations of the present preferred embodiment in the reproduction mode;

FIG. 13 is a sample view showing the initial screen;

FIG. 14 is a sample view showing edit screen A;

FIG. 15 is a sample view showing edit screen B;

FIG. 16a is a schematic drawing of the data structure of the scenario file defining reproduction order;

FIG. 16b is a schematic drawing of the data structure of the scenario file defining reproduction style;

FIG. 17 is a sample view showing edit screen C;

FIG. 18 is a sample view showing edit screen D;

FIG. 19 is a sample view showing edit screen E;

FIG. 20 is a sample view showing the screen during the reproduction mode; and

FIG. 21 is a schematic drawing explaining the staged structure of the reproduction order.

### DETAILED DESCRIPTION OF EMBODIMENTS

Preferred embodiments of the present invention are explained below, based on the drawings.

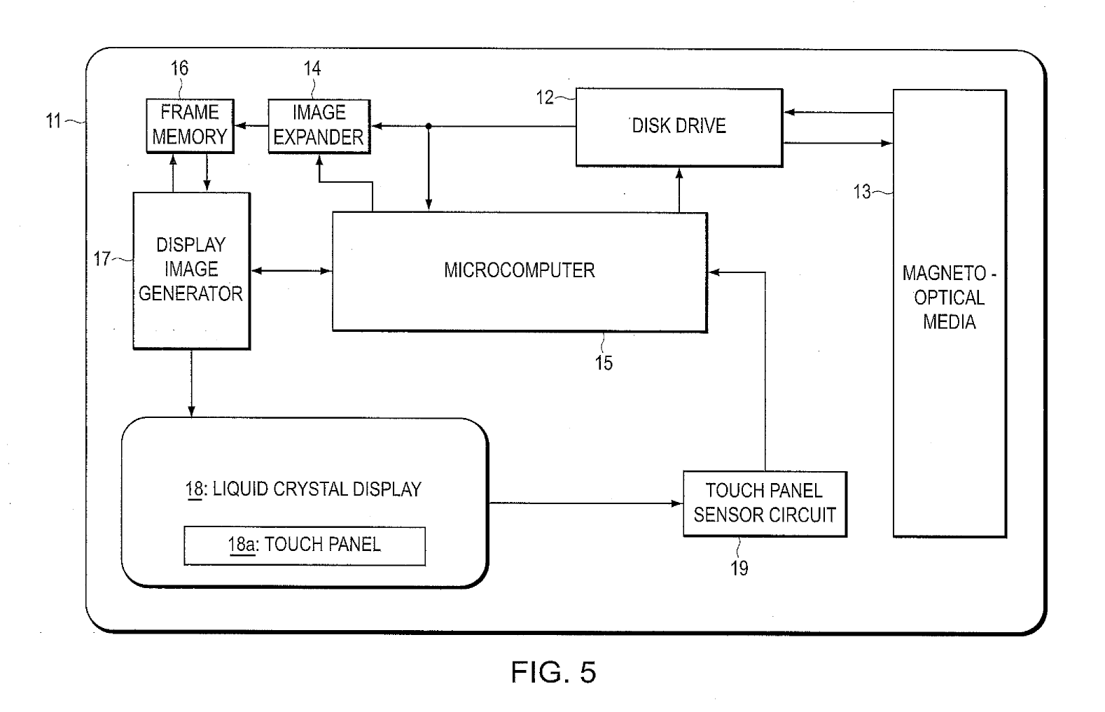

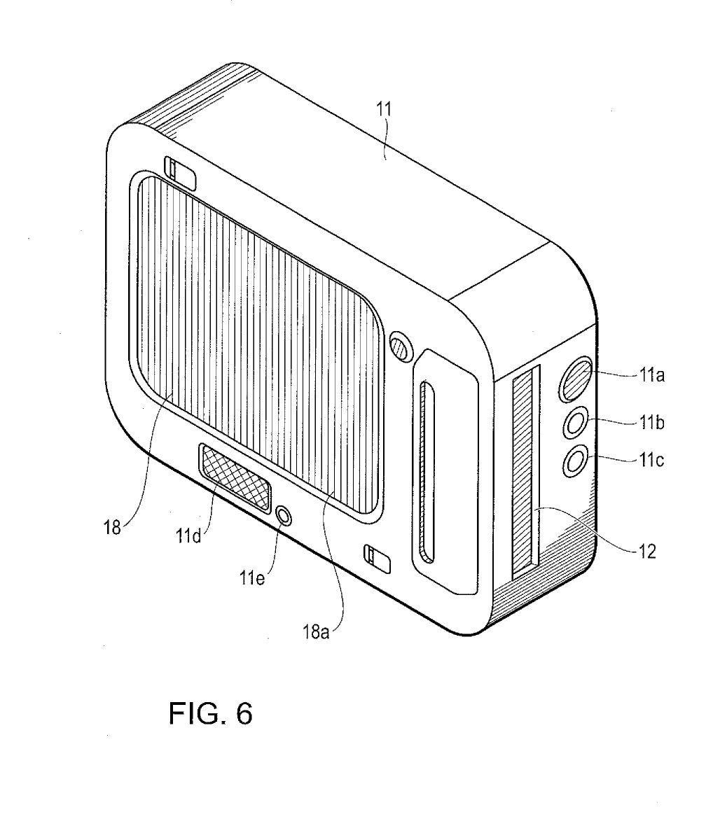

Best seen in FIGS. 5 and 6, the image reproduction device 11 according to the preferred embodiments of this invention has a disk drive 12 disposed therein. Recording media 13, preferably magnetooptical media, are installed externally into the disk drive 12. The data output of the disk drive 12 is connected to an image expander known as a decompressor 14 and a microcomputer or microprocessor 15. The image output of the image decompressor 14 is connected via frame memory 16 to a display image generator 17.

The output of the display image generator 17 is connected to a display, preferably a liquid crystal display (LCD) 18, placed at the front of the image reproduction device 11. A touch panel 18a that senses the pressure of a finger or pen is adhered to LCD 18. The output of the touch panel 18a is connected to a touch panel sensor circuit 19. The output of the touch panel sensor circuit 19 is input into the microprocessor 15. Also, the control input/output and data output of the microprocessor 15 are connected variously to the image decompressor 14, the disk drive 12, and the display image generator 17.

Furthermore, on the housing or case of the main body of the image reproduction device 11 are placed an S output terminal 11a, an image output terminal 11b, a sound output terminal 11c, a speaker 11d, and an earphone jack 11e, which are each variously connected to an internal amplifier circuit (not shown).

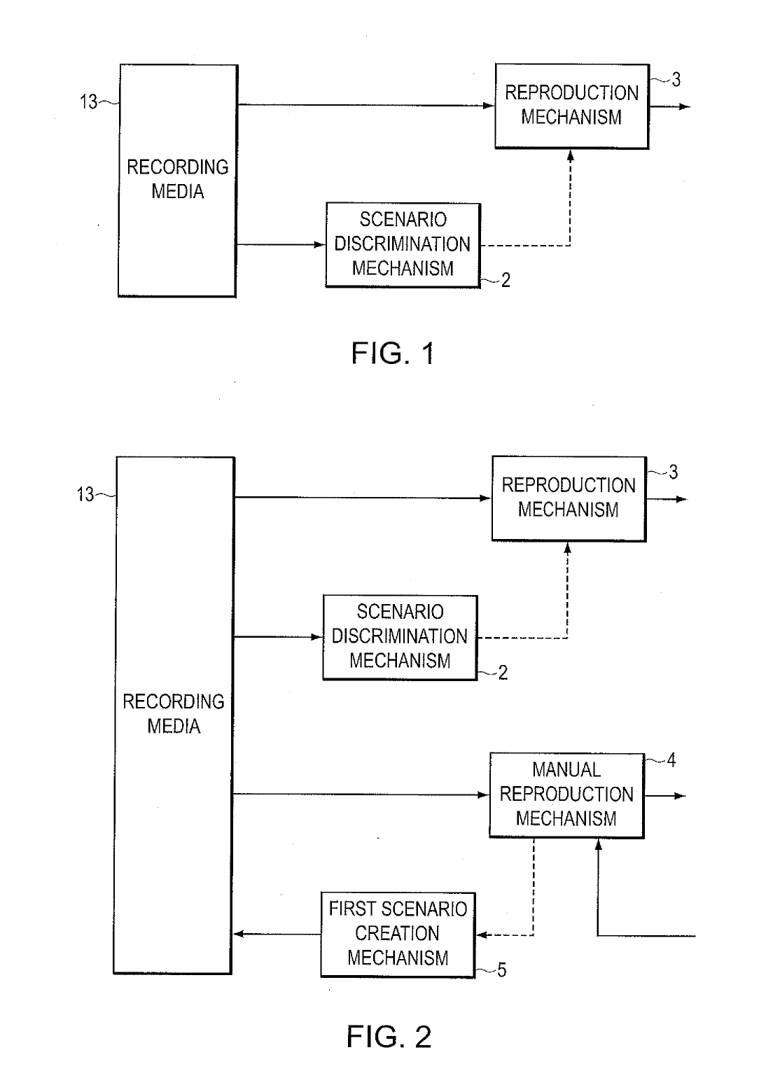

FIGS. 1-4 show high level schematic block diagrams describing the basic operation of the present invention. In FIG. 1, the magnetooptical recording media 13 stores the scenario file for the scenario discrimination mechanism 2, which corresponds to the function discriminating data structures of scenario files of the disk drive 12 and the microprocessor 15. The recording media 13 also stores the image files for the reproduction mechanism 15, which corresponds to the disk drive 12, the image decompressor 14, the frame memory 16, and the display image generator 17.

FIG. 2 shows an additional manual reproduction mechanism 4 corresponding to the function of controlling the display output generator 17, etc., according to manual reproduction operations of the touch panel 18a, the touch panel sensor circuit 19, and the microprocessor 15. The first scenario creation mechanism 5 corresponds to the function of creating scenario files according to manual operations of the microprocessor 15.

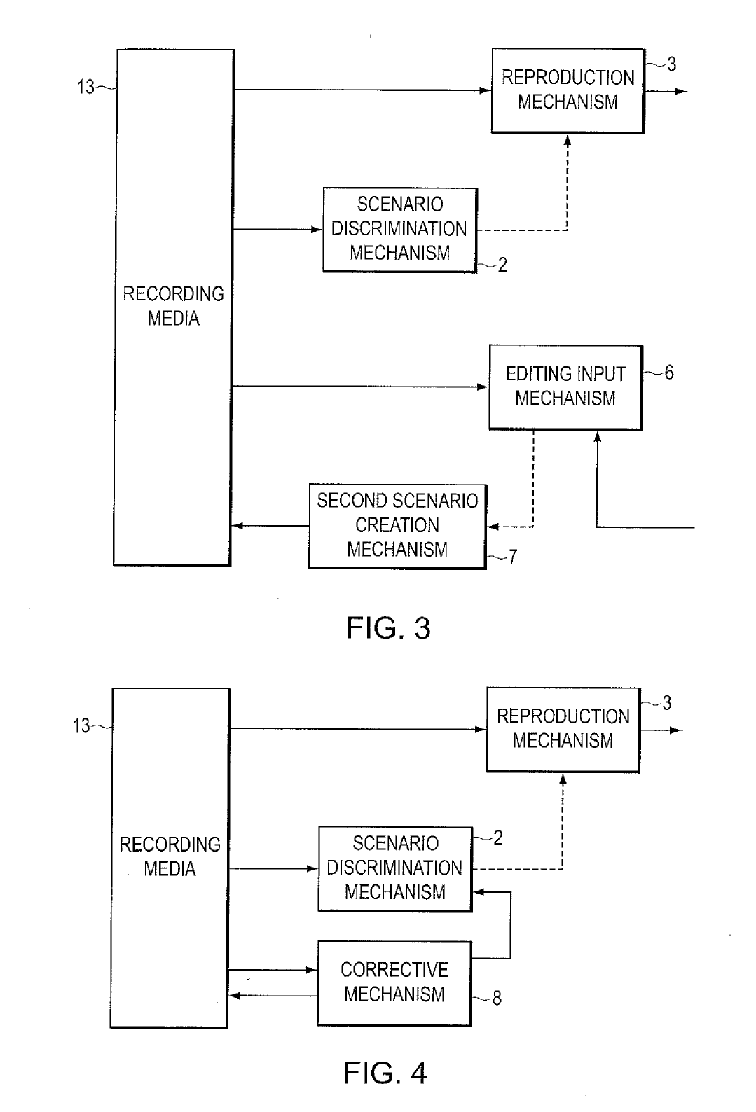

As seen in FIG. 3, the editing input mechanism 6 corresponds to the function of discriminating editing operations of the touch panel 18a, the touch panel sensor circuit 19, and the microprocessor 15. The second scenario creation mechanism 7 corresponds to the function of creating scenario files according to editing operations of the microprocessor 15. The editing or corrective mechanism 8 of FIG. 4 corresponds to the function of editing scenario file data of the microprocessor 15.

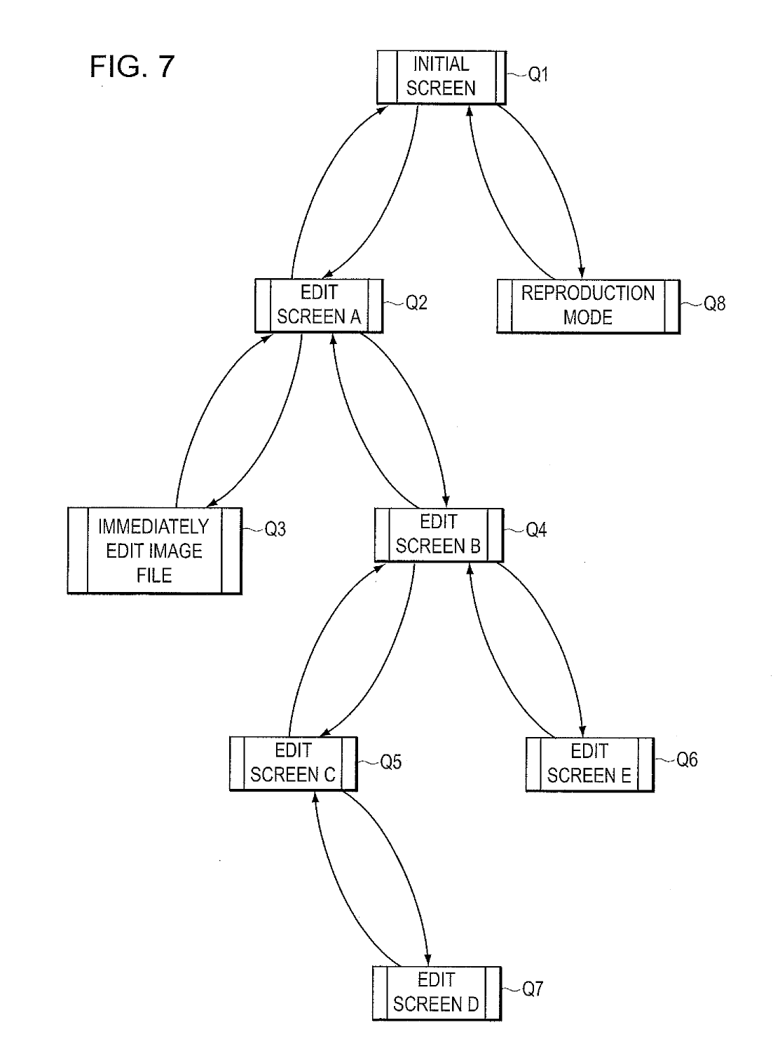

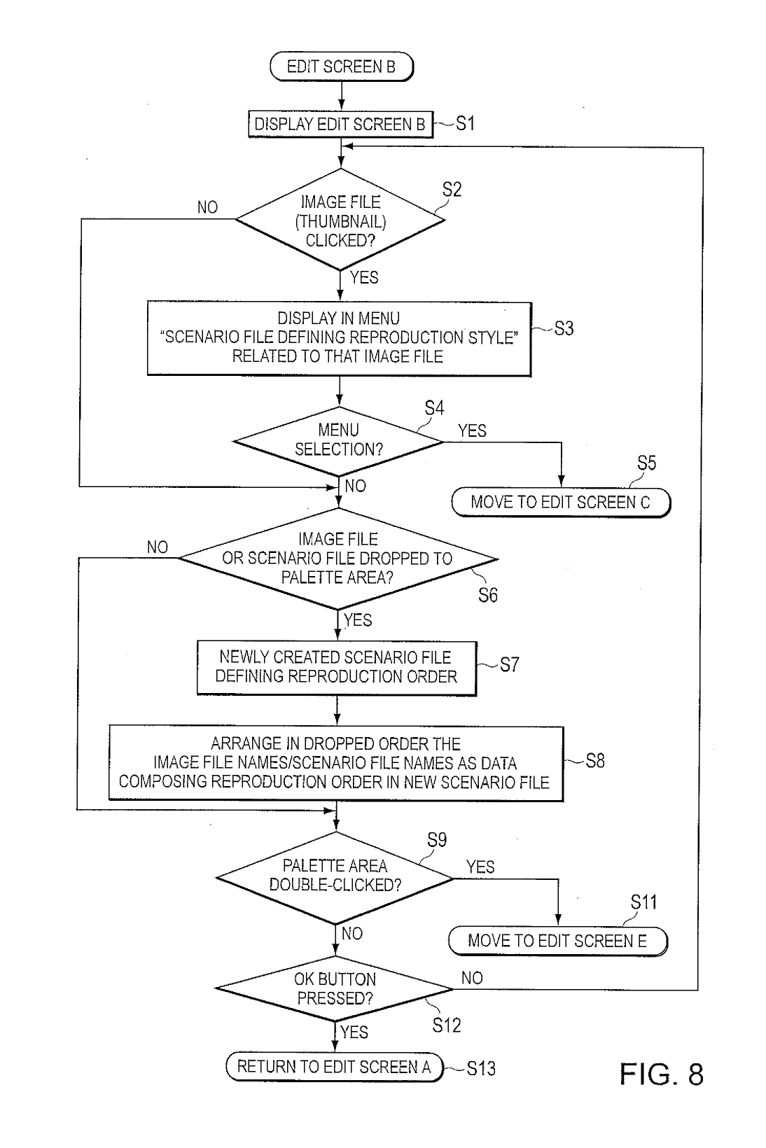

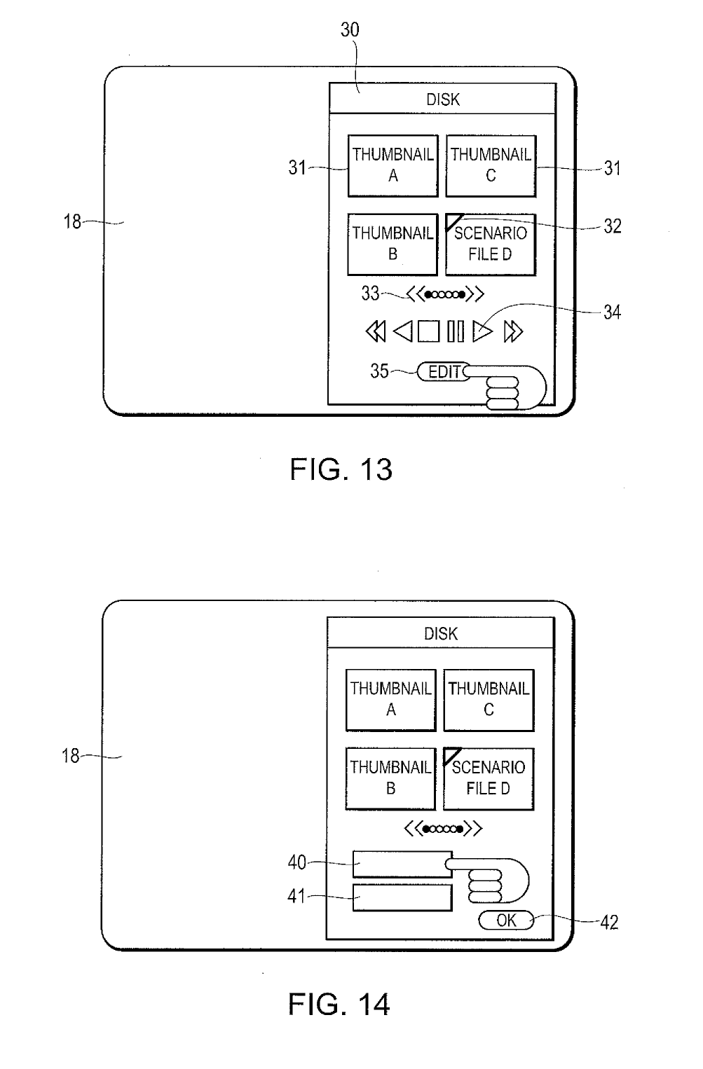

FIG. 7 is a state transition diagram explaining the operations of the present preferred embodiment, and FIGS. 8-12 are flow charts explaining the operations of the present preferred embodiment. The operations of the present preferred embodiment are explained below in conjunction with the transition of the display screens of the LCD 18, shown in FIGS. 13-15. The display screens are intended as examples only. It will be apparent to those skilled in the art that the placement and design of the display elements can vary depending on designer or user preferences.

First, when the power source is turned on, the display image generator 17 displays an initial screen as shown in FIG. 13 to the LCD 18. On the initial screen is displayed a small window 30 for receiving reproduction operations. On the upper half of the small window 30 are listed thumbnail images 31. For example, these thumbnail images 31 are reduced images displaying the leading frames of the image files recorded on the magnetooptical recording media 13.

Images having applied scenario file identification marks 32 are displayed with these thumbnail images 31. These images correspond to the scenario files, which define either the reproduction order or reproduction style. The leading frames of the related image files are displayed in reduction.

Below these thumbnail images 31 is displayed a scroll button 33 for scrolling the list of thumbnail images 31. Below the scroll button 33 are displayed a reproduction (play) button 34 and other conventional buttons for instructing the reproduction operations. Below the play button 34 is displayed an edit button 35. When clicking this edit button 35 with a finger, or the like, the touch panel 18a senses a pressing operation.

The touch panel sensor circuit 19 senses the coordinates of the pressed location from the touch panel 18a and relays them to the microprocessor 15. The microprocessor 15 relays to the display image generator 17 a message indicating that “the edit button 35 has been clicked,” corresponding to the coordinates of the pressed location. According to the message indicating that “the edit button 35 has been clicked,” the display image of the LCD 18 is changed by the display image generator 17 to an edit screen A as shown in FIG. 14.

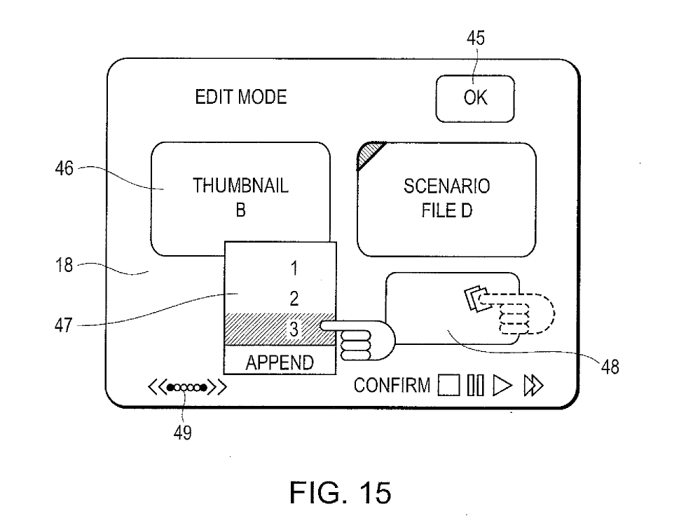

Edit screen A displays a scenario edit button 40, a video edit button 41, and an OK button 42 (in place of the play button 34 and the edit button 35 on the initial screen mentioned above). When the OK button 42 is clicked on this screen, the display image generator 17 returns the display screen to the initial screen. Meanwhile, when the video edit button 41 is clicked on this screen, the microprocessor 15 moves to the video edit mode for actually linking the image files on the magnetooptical recording media 13. Also when the scenario edit button 40 is clicked on this screen, the display image generator 17 changes the display screen to edit screen B, shown in FIG. 15.

Edit screen B displays an OK button 45 at the top right and the thumbnail images 46 horizontally in the middle of the screen. Also, a palette area 48 is displayed at the bottom right of the screen. At the bottom left of the screen is displayed a scroll button 49 for scrolling the arrayed display of thumbnail images 46.

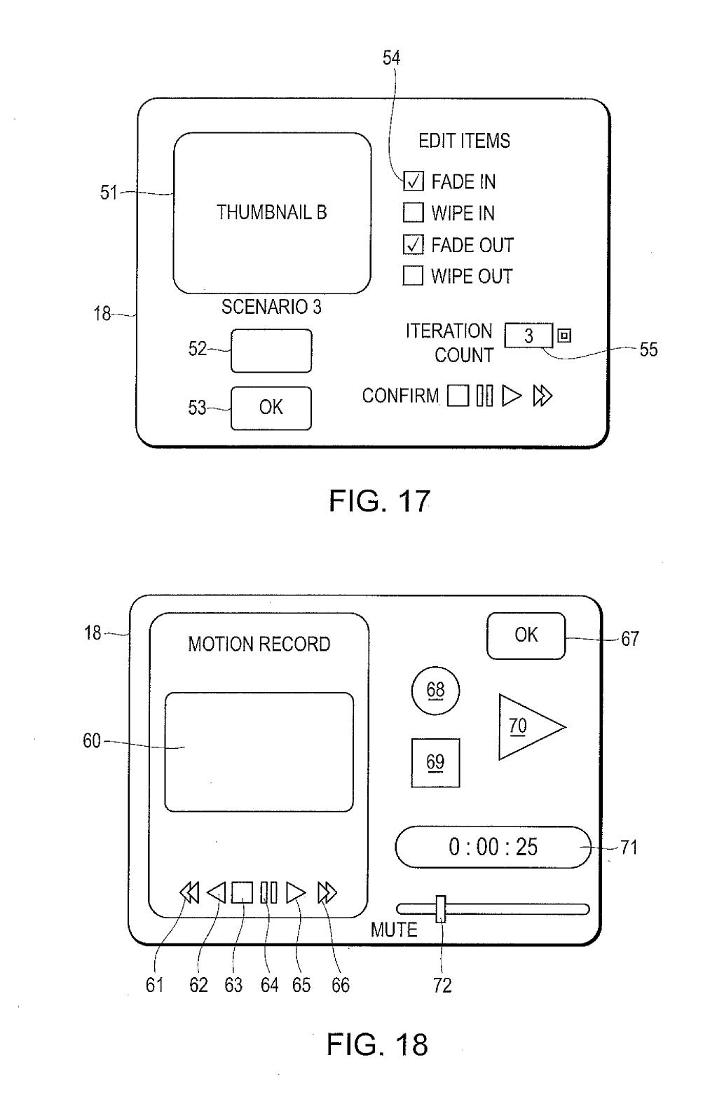

The operations of the preferred embodiment in edit screen B are explained below based on the flow chart shown in FIG. 8. First, the display image generator 17 displays edit screen B to the LCD 18 (S1). When a thumbnail image 46 is clicked (S2) in this state, the microprocessor 15 discriminates which thumbnail image file is selected, and displays as a menu 47 a list of the “scenario files defining reproduction style” related to that image file. Here, when one option on the menu 47 is clicked (S4), the display image generator 17 changes the display screen to edit screen C, shown in FIG. 17.

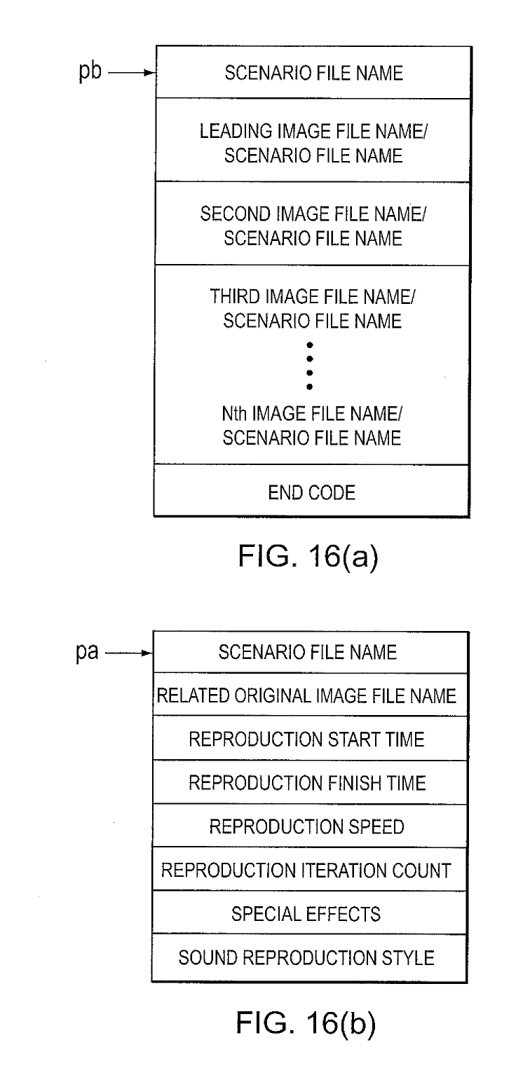

Meanwhile, when a thumbnail 46 or menu 47 is drag-and-dropped to the palette area 48 (S6), the microprocessor 15 newly creates a “scenario file defining reproduction order” on a recording area of the magnetooptical recording media (S7). Here, the data structure of the “scenario file defining reproduction order” is shown in FIG. 16(a). In this data structure, the following data is stored in order from the leading data indicated by pointer pb: 1) scenario file name; 2) leading image file name or scenario file name; 3) second image file name or scenario file name . . . ; n+1) file name or scenario file name.

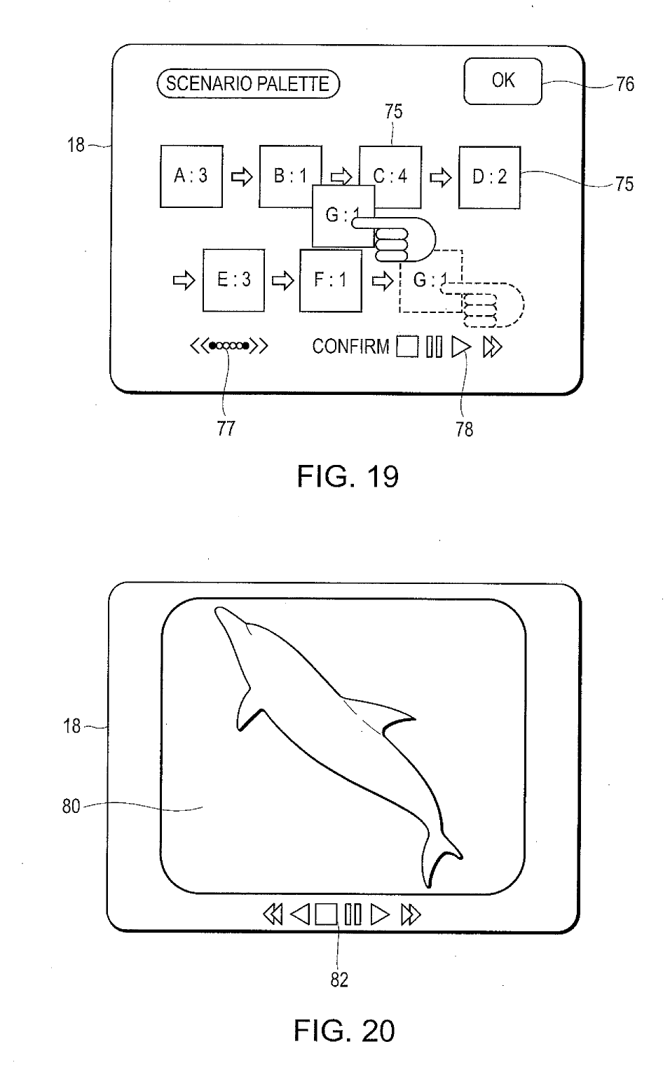

The microprocessor 15 appends either the corresponding image file name or scenario file name to the data of the new scenario file each time a thumbnail image 46 or menu 47 is dropped to the palette area 48 (S8). Also, when the palette area 48 is double-clicked in edit screen B (S9), the display image generator 17 changes the display screen to edit screen E, shown in FIG. 19 (S11). Meanwhile, when the OK button 45 is clicked (S12) in edit screen B, the display image generator 17 returns the display screen to edit screen A (S13).

As described above, new creation of “scenario files defining reproduction order” is performed mainly in edit screen B.

Edit screen C shown in FIG. 17 shows the thumbnail images 51 of the “scenario file selected by menu in edit screen B” displayed on the upper left. Below the thumbnail images 51 are displayed a motion REC (record) button 52 and an OK button 53. Also, on the top right of the screen vertically displays a special effects check box 54. Below the special effects check box 54 is displayed an iteration count edit box 55.

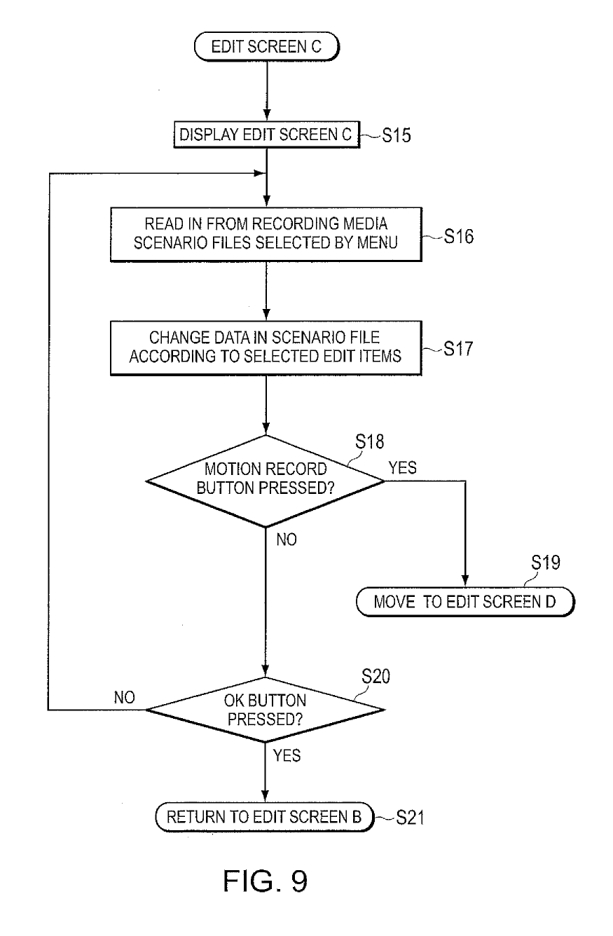

The operations of the preferred embodiment in edit screen C are explained below based on the flow chart shown in FIG. 9. First, the display image generator 17 displays edit screen C to the display screen (S15). The microprocessor 15 reads out from the magnetooptical recording media 13 the “scenario files defining reproduction style” selected by menu in edit screen B (S16).

When an “append” column as shown in FIG. 15 is selected by menu, the microprocessor 15 newly creates a “scenario file defining reproduction style.” Here, the data structure of the “scenario file defining reproduction style” is shown in FIG. 16(b). In this data structure, the following data is stored in order from the leading data indicated by pointer pa: 1) scenario file name; 2) related original image file name; 3) reproduction start time; 4) reproduction finish time; 5) reproduction speed (pause, reverse, play, fast-forward, etc., stored in time series); 6) reproduction iteration count; 7) special effects (fade in, wipe in, etc.); and 8) sound reproduction style (volume, etc., stored in time series).

The microprocessor 15 changes the corresponding data inside the scenario file each time the special effects check box 54 and iteration count edit box 55 are changed (S17).

Meanwhile, when the motion REC button 52 is clicked in the edit screen C (S18), the display image generator 17 displays edit screen D shown in FIG. 18 to the display screen (S19). Also, when the OK button 53 is clicked in edit screen C (S20), the display image generator 17 returns the display screen to edit screen B (S21).

As described above, new creation and data updating of the “scenario files defining reproduction style” are performed mainly in edit screen C.

In edit screen D shown in FIG. 18, the reproduction screen 60 is displayed on the left of the screen and below the reproduction screen 60 are displayed, in order from the left, a fast-backward (rewind) button 61, a reverse reproduction (play) button 62, a stop button 63, a pause button 64, a forward reproduction (play) button 65, and a fast-forward button 66.

Also, on the top right of the screen is placed an OK button 67. In the middle right of the screen are displayed a set start button 68, a set finish button 69, and a confirm button 70. Furthermore, at the bottom right of the screen are displayed a time display box 71 that displays the reproduction time and a volume adjustment bar 72 that adjusts the reproduction volume.

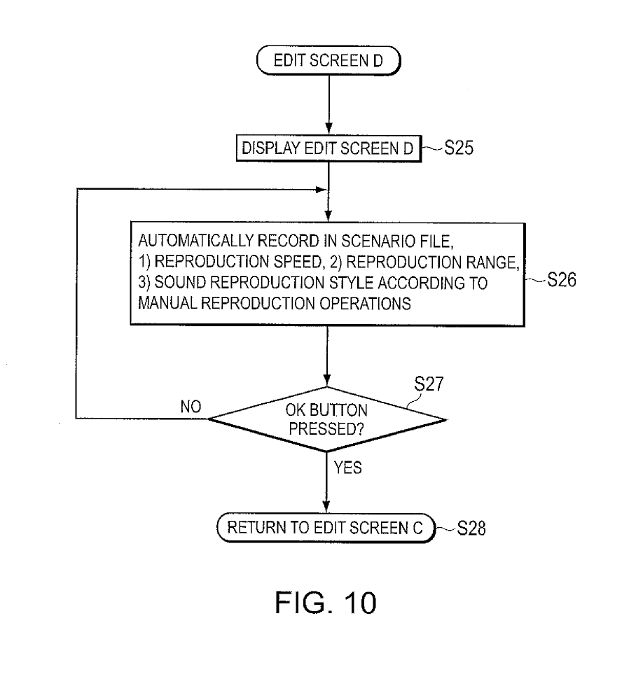

The operations of the preferred embodiment in edit screen D are explained below based on the flow chart shown in FIG. 10.

First, the display image generator 17 displays edit screen D to the display screen (S25). In this edit screen D, the microprocessor 15 takes in the manual reproduction operations corresponding to the play button 65, and the like. Here, the microprocessor 15 reads out from the magnetooptical recording media 13 the original image files related to the “scenario files selected by menu in edit screen B.” The image files read out in this manner are decompressed in the image decompressor 14 and sequentially stored in the frame memory 16.

Meanwhile, the display image generator 17 reproduces the images from the frame memory 16 according to the reproduction operation messages provided from the microprocessor 15. For example, when the fast-forward button 66 is pressed, the display image generator 17 reads out the images several frames ahead from the frame memory 16 and sequentially displays them to the reproduction screen 60. Also, when the pause button 64 is pressed, the display image generator 17 repeatedly reads out one frame of an image from the frame memory 16, and displays it to the reproduction screen 60.

When the set start button 68 is clicked during such reproduction time, the microprocessor 15 writes the frame number of the image file presently displayed on the reproduction screen 60 to the data area of the reproduction start time in the scenario file. After this time the microprocessor 15 writes the reproduction change of speed to the data area of the reproduction speed in the scenario file.

Also, when the volume adjustment bar 72 is operated, the microprocessor 15 writes the change of reproduction volume to the data area of the sound reproduction style in the scenario file.

Here, when the set finish button 69 is clicked, the microprocessor 15 writes the frame number of the image file presently displayed on the reproduction screen 60 to the data area of the reproduction finish time of the scenario file (S26). In this state, when the OK button 67 is clicked in edit screen D (S27), the display image generator 17 returns the display screen to edit screen C (S28). By the operations described above, the manual reproduction operations are recorded automatically in edit screen C.

In edit screen E shown in FIG. 19, an OK button 76 is displayed at the top right of the screen, and the thumbnail images 75 are displayed across several lines in the middle of the screen. Also, at the bottom left of the screen are displayed a scroll button 77 for scrolling the linear display and the reproduction operation buttons 78 for confirmation.

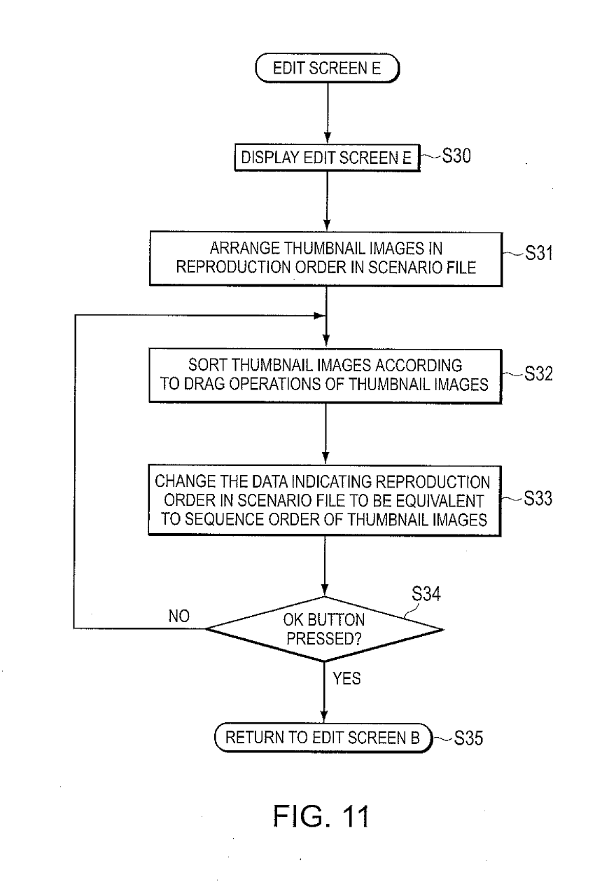

The operations of the preferred embodiment in edit screen E are explained below based on the flow chart shown in FIG. 11. The display image generator 17 displays edit screen E to the display screen (S30). Next, the created scenario files are loaded using the palette area 48 of edit screen B. The display image generator 17 displays in an array the thumbnail images 75 based on the reproduction order defined in these scenario files (S31). Here, when one thumbnail image 75 is dragged, the display image generator 17 moves that thumbnail image 75 following the motion of the drag operation. Furthermore, when this thumbnail image 75 is dropped between two thumbnail images, the display positions of the entirety are sorted by inserting the thumbnail image 75 between them (S32). The microprocessor 15 sorts the data indicating the reproduction order among the scenario files to be equivalent to the sequence order of these thumbnail images 75 (S33).

Meanwhile, when the OK button 76 is clicked in edit screen E (S34), the display image generator 17 returns the display screen to edit screen B (S35). By the edit operations described above, it is possible with edit screen E to change with ease the data indicating the reproduction order among the scenario files.

When the reproduction operation buttons 78 for confirmation shown in FIG. 18 are operated during the edit operations described above, the microprocessor 15 produces a small window for the reproduction screen and reproduces within that small window the files in order following the present reproduction order.

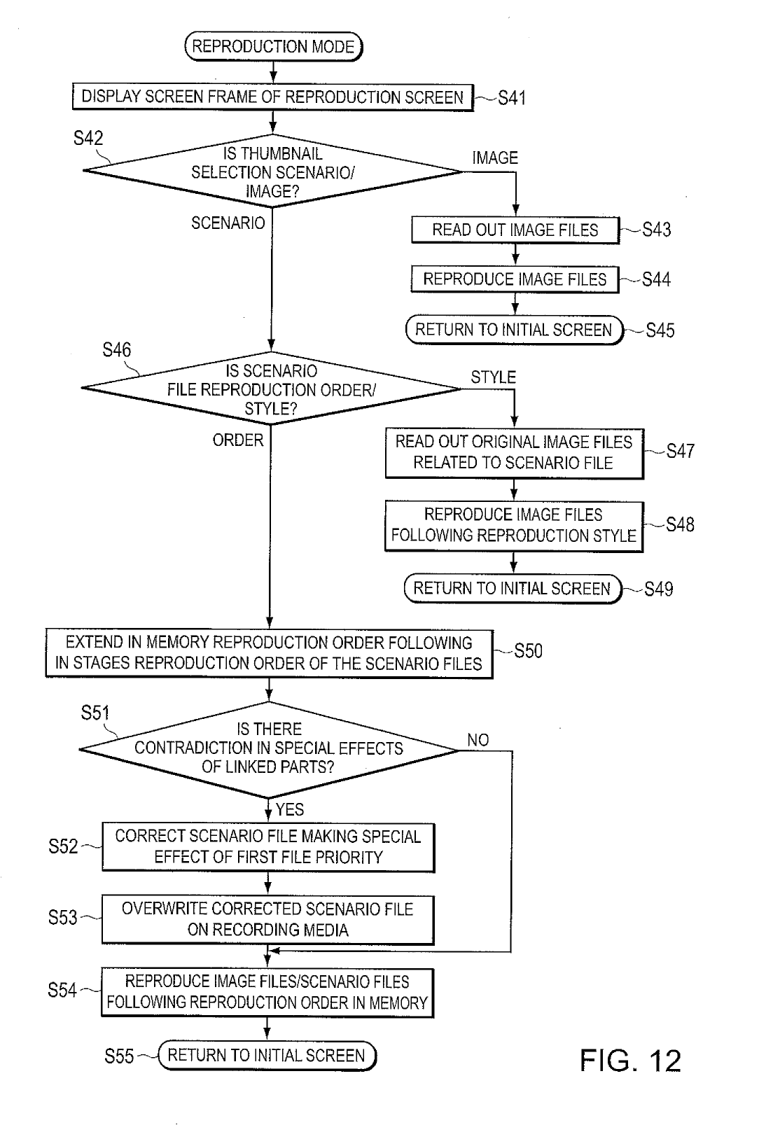

FIG. 20 is a drawing showing the display screen during reproduction. On the screen, the reproduction screen 80 is enlarged. Below the reproduction screen 80 the reproduction operation buttons 82 are displayed. The reproduction operations of the preferred embodiment are explained based on the flow chart shown in FIG. 12.

First, the display image generator 17 displays the screen frame of the reproduction screen 80 (S41). Next, the microprocessor 15 discriminates whether the files selected by thumbnail on the initial screen are image files or scenario files (S42). Here, when image files are selected by thumbnail, the microprocessor 15 reads out the images file from the magnetooptical recording media 13 via the disk drive 12 (S43).

The image decompressor 14 decompresses the data of these image files and stores them sequentially in the frame memory 16. The display image generator 17 displays sequentially to the reproduction screen 80 the image information in the frame memory 16 (S44). After completing reproduction of the above image files, the display image generator 17 returns the display screen to the initial screen (S45).

Meanwhile, when scenario files are selected in step S42, the microprocessor 15 discriminates whether the reproduction order or the reproduction style was defined based on the data structures of the scenario files (S46). Here, in the case of scenario files defining the reproduction style, the microprocessor 15 reads out the original image files related to the scenario files from the magnetooptical recording device 13 via the disk drive 12 (S47).

Next, the microprocessor 15 receives the data of the reproduction start time and reproduction finish time from the data structures of the scenario files, and transfers this data to the image decompressor 14. The image decompressor 14 decompresses the data following the frame sequences from the reproduction start time, and stores the data sequentially in the frame memory 16. The display image reproduction component 17 relays the frame numbers of the images in the frame memory 16 to the microprocessor 15.

The data of the reproduction speed, sound reproduction style, special effects, etc., in the scenario files are relayed by the microprocessor 15 to the display image generator 17 in synchronization with the advance of the frame numbers.

The display image generator 17 changes the time intervals of the frame display and the reproduction style, special effects, etc., of the sound data included in the image files (S48).

The image decompressor 14 finishes expansion processing of the image files, in addition to decompressing the frame at the reproduction finish time. After the reproduction of the images in the frame memory 16 is finished, the display image generator 17 returns the display screen to the initial screen (S49).

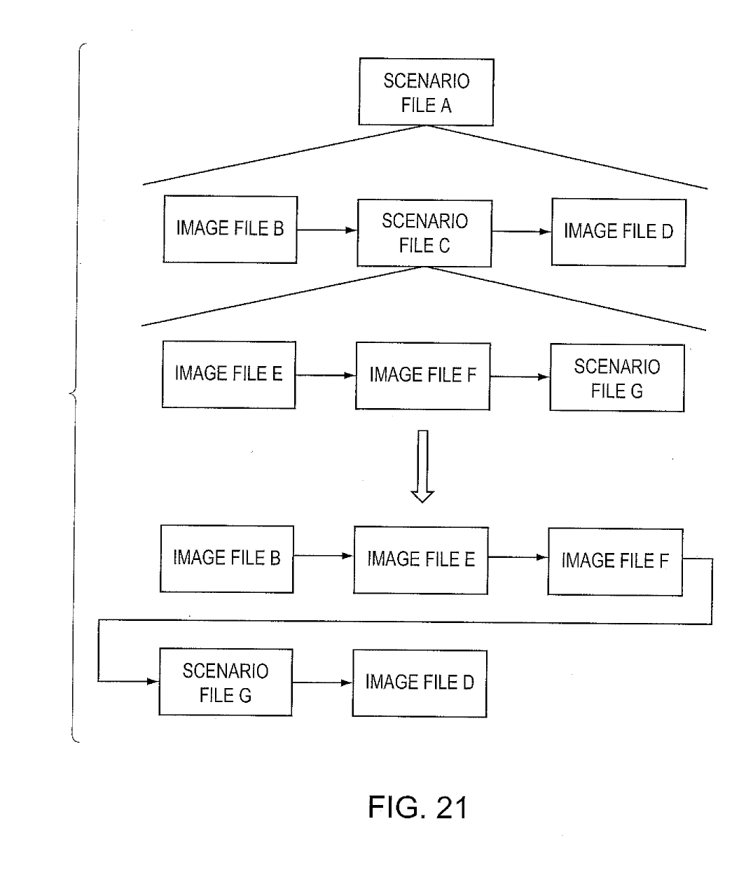

Meanwhile, in step S46, the microprocessor 15 reads out the scenario files from the magnetooptical recording media 13 via the disk drive 12 when they are discriminated as scenario files defining the reproduction order. Here, the microprocessor 15 extends the data of reproduction order in the internal memory of the microprocessor 15 (S50) by following in stages the reproduction order as shown in FIG. 21.

That is, in the case as shown in FIG. 21, the data: (image file B→scenario file C→image file D) is recorded in scenario file A. Thus, the microprocessor 15 reads out, following in stages, scenario file C defining the reproduction order.

In scenario file C, the data: (image file E→image file F→scenario file G) is recorded. Here, because scenario file G has defined reproduction style, the reproduction order is not followed besides this.

As a result, the reproduction order extended in memory becomes: (image file B image file E→image file F→scenario file G→image file D).

Here, the microprocessor 15 traces the linked locations among the scenario files defining the reproduction style and discriminates based on a fixed reference table as to whether or not a contradiction has occurred in the special effects, etc., of the linked locations (S51).

For example, when fade out and wipe in are mutually defined, it is discriminated that a contradiction has occurred. When such a contradiction has occurred, because the special effects of the first scenario file have priority, the microprocessor 15 deletes the corresponding data of the later scenario file (S52). The microprocessor 15 overwrites the revised scenario file on the magnetooptical recording media 13 (S53).

In such a state having resolved the contradiction, the microprocessor 15, image decompressor 14, and display image generator 17 reproduce either the image files or the scenario files according to the reproduction order extended in memory (S54).

The display image generator 17 returns the display screen to the initial screen after reproduction of the images in the frame memory 16 is finished (S55).

As explained above, with this preferred embodiment, scenario files of comparatively small file capacity are recorded on the magnetooptical recording media 13 instead of the image files after editing is finished. Also, because the reproduction order is reconstructed by following the scenario files in stages, the file structures of the scenario files can be simplified one-by-one.

Because edited scenario files can be incorporated as they are into the existing scenario files, reusability of the scenario files becomes higher and workability of the image editing can be increased. Furthermore, because scenario files are created by automatically recording the manual reproduction operations, it becomes possible to simply perform the creation of scenario files. Also, because reproduction can be performed following these scenario files from the second round on, the need to repeat complicated manual reproduction operations entirely disappears. Scenario files can be created based on advanced editing operations, so complex editing items that cannot be specified by manual reproduction operations can be included in the scenario files. Furthermore, because contradictions of scenario files are corrected automatically following a predefined priority order, there is no fear that the reproduced images would cause interference due to contradictions of the image files following the scenario files.

Also, in this preferred embodiment, because the scenario files that define reproduction style and reproduction order are separated, the file structure of the scenario files becomes simpler. Thus, it becomes possible to reduce the information processing load required for interpretation of the data structures.

In the preferred embodiment as described above, the scenario files that define reproduction style and reproduction order are separated. However, scenario files that define both reproduction style and reproduction order may be used by including both data structures in a single scenario file. Further, the scenario files may be made recordable in a part of the image files.

Furthermore, in the preferred embodiment as described above, magnetooptical recording media 13 is used as the recording media, but the present invention is not restricted by the material or the formal structure of the recording media. Any recording media capable of recording image information is acceptable. For example, optical recording media and magnetic recording media are also acceptable.

Also, in the preferred embodiment as described above, when there are contradictions in the scenario files, reproduction of the first image is automatically given priority, but the present invention is not restricted to that. For example, reproduction of the subsequent image may be automatically given priority, or the one given priority may be established precisely according to each type of contradiction. Also, the priority instructions also may be made receivable externally via the touch panel 18a during the occurrences of contradictions.

Furthermore, in the preferred embodiment as described above, contradictions in the scenario files are corrected automatically during reproduction, but the present invention is not restricted to that. For example, during the editing operations as shown in FIG. 19, or while performing operations for confirmation, the contradictions of the scenario files may be corrected automatically, or the operator may be warned of the contradictions. In such structures, it becomes possible to correct the contradictions quickly and thoroughly by rapidly discovering the contradictions during editing of the scenario files.

As explained above, the invention records on the recording media scenario files of small file capacity instead of the image files after editing is finished. In particular, in cases where the same cut is repeatedly shown, the need to repeatedly and redundantly record the same cut in the image file after editing is finished, as in the prior art, entirely disappears. It is sufficient to record at least only the identifying information (file name, etc.) of the image file of the same cut. Consequently, the recording capacity of the recording media can be used efficiently without waste.

Because the invention discriminates the reproduction order by following in stages the scenario files, the file structure of each individual scenario file can be simplified. Also, because edited scenario files can be incorporated in stages into scenario files, the reusability of the scenario files can be extremely high. Because the invention creates scenario files by automatically recording the manual reproduction operations, creation of the scenario files can be simplified. Also, because automatic creation can be performed by following these scenario files, the need to repeat complicated manual reproduction operations disappears.

Because the invention creates scenario files based on editing operations, it becomes possible to create advanced scenario files by specifying complex editing items. Also, because creation of image files after finishing editing is not necessarily required, the recording capacity of the recording media can be used efficiently.

In the invention, contradictions of the scenario files are corrected automatically according to a predefined priority order and corrective instructions. Consequently, even when there are contradictions in the scenario files, image reproduction can be performed well enough without interference.

As explained above, with a image reproduction device applying the present invention, image files can be reproduced freely in either a fixed reproduction order or reproduction style while efficiently using the recording capacity of the recording media.

While advantageous embodiments have been chosen to illustrate the invention, it will be understood by those skilled in the art that various changes and modifications can be made therein without departing from the scope of the invention as defined in the appended claims.

What is claimed is:

1. A digital image data recording and reproducing apparatus comprising:
a random accessible rewritable memory medium;
a recording unit that accesses the random accessible rewritable memory medium to record on the memory medium a plurality of data files, each of which has moving digital image data, the recording unit also accesses the memory medium to reproduce the moving digital image data; and
a processor, electrically connected to the recording unit, that (1) produces a scenario file which includes a first type of data structure defining reproduction order and a second type of data structure defining reproduction style, and (2) causes the recording unit to record the scenario file on the random accessible rewritable memory medium in response to a user operation, the first type of data structure indicating a reproduction order for reproducing at least two of the plurality of data files selected from among the plurality of data files, the second type of data structure including information about at least one of the data files, and (3) changes the data files and the scenario file in response to a user operation after recording the data files and the scenario file on the random accessible rewritable memory medium.
